(19) United States
(12) Patent Application Publication
(10) Pub. No.: US 2022/0245350 A1
(43) Pub. Date: Aug. 4, 2022

(54) FRAMEWORK AND INTERFACE FOR MACHINES

(71) Applicant: CAMBIUM ASSESSMENT, INC., WASHINGTON, DC (US)

(72) Inventor: Christopher Ormerod, Hyattsville, MD (US)

(73) Assignee: CAMBIUM ASSESSMENT, INC., WASHINGTON, DC (US)

(21) Appl. No.: 17/166,653

(22) Filed: Feb. 3, 2021

(51) Int. Cl. G06F 40/30; G06F 40/284; G06N 3/04; G06N 3/08

(52) U.S. Cl. CPC G06F 40/30; G06N 3/08; G06N 3/04; G06F 40/284

(57) ABSTRACT

A natural language processor can include a memory storing executable software code and a processor for implementing commands of the executable software code. The code can include a software framework and/or an application programming interface. The code can include commands to direct the processor to normalize the raw text into normalized text, to tokenize the normalized text into a collection of tokens, to map the collection of tokens into a finite dimensional real vector space of features, and to classify the finite dimensional real vector space to approximate a set of training data based on a collection of parameters. The API can encapsulate a collection of natural language classifiers. The natural language processor can be configured to receive raw text.

### TECHNICAL FIELD

The present invention relates to systems and methods of machine learning for natural language processing.

### BACKGROUND

Artificial neural networks typically include large numbers of interconnected processing elements called neurons. Neural networks can employ machine learning. For example, a neural network can learn through learn through experience to recognize patterns, classify data, devise complex models, and create new algorithms. This experiential learning can be based on sample data, commonly called training data, used to in order to make and check predictions.

Problems faced in natural language processing are amongst the most difficult in the machine learning community. Previous approaches typically focused on a single neural network model for training in a silo type of architecture. Work on neural network ensembles typically dealt with each neural network separately.

### SUMMARY

The present invention is generally directed to systems and methods for machine learning and/or natural language processing. A system executing the methods can be directed by a program stored on non-transitory computer-readable media.

An aspect can include a natural language processor having a memory and a processor. The memory can include executable software code. The processor can implement commands of the executable software code. The executable software code can include a software framework and/or an application programming interface (API). The API can encapsulate a collection of natural language classifiers. Natural language classifiers can be configured to receive raw text.

In an embodiment, the executable software code can include commands to direct the processor to normalize the raw text into normalized text, to tokenize the normalized text into a collection of tokens, to map the collection of tokens into a finite dimensional real vector space of features, and/or to classify the finite dimensional real vector space to approximate a set of training data based on a collection of parameters.

In another embodiment, the processor and/or the executable software code can be configured to normalize the raw text, to map each of tokens to a finite dimensional vector space via a word-embedding, which can then be processed by a neural network to map the collection of tokens to a fixed dimensional real vector space of features, which can be classified.

In yet another embodiment, the application programming interface can include an initialization command that defines parameters of a model, a fit command that fits the parameters to the training data, a save command that saves or loads the model to the memory; and/or a score command that predicts a score based on the training data. In some embodiments, the processor and/or the executable software code can be configured to train the natural language processor based on raw text.

Embodiments can include a software framework for use by non-experts that simplifies the development and deployment process of a wide range of text-classifiers. The framework can be specifically and/or uniquely designed to automate preprocessing, normalization, tokenization, and/or embedding processes involved in both training and inference so that the user need only deal with raw text input.

Embodiments can include an ensembler. A software framework can sit between a user interface and the ensembler. The ensembler can be configured to instantiate machine objects based on the machine class. Each of the machine objects can be configured to load a model, to generate a score based on the training data and the model, and/or to save the score. A framework for ensembles of text classifiers can be combined with confidence models and can report both a score and a measure of how confident the model is of that score. This can give a user an option to review scores of which the model is not sufficiently confident.

Embodiments can include an aggregator. The software framework can sit between a user interface and the aggregator. The aggregator can be configured to instantiate ensemblers. The ensemblers can be configured to produce confidence statistics, to generate a score based on the training data and the model, and/or to save the score.

Embodiments can abstract away differences in the development and/or deployment of a wide variety of heterogeneous classical and/or neural network-based classifiers. An API can encapsulate a encapsulate a general machine class. Natural language classifiers can inherit from a general machine class of an API. Each classifier can admit, for example, five commands associated with instantiation, training, saving/loading, and/or inference. This can simplify text-classification in a way in which almost all the choices available to an expert in the field can be provided in the instantiation step in a uniform way while allowing non-experts to quickly and easily experiment with very sophisticated variations of available models.

The framework can allow non-experts to seamlessly add and/or remove models in an ensemble to meet either accuracy or compute-time requirements. The framework can be built so that ensembles can be deployed as easily as any other model. By distilling the key features of text-classification models into one abstract class, the framework can be extended to incorporate the models of the future with an appropriate wrapper. This can enable any user who is familiar with the framework to use the latest machine learning/neural network models in a variety of languages when a wrapper is made available. A suite of tools can allow iterating and tuning traditional hyperparameters such as the learning rates, dropouts and normalization constants, in addition to non-traditional hyperparameters such as parameters associated with preprocessing methods, in the one interface. The framework can simplify development with GPU and TPU architectures. This can enable users to experience accelerated training speeds with no additional coding requirements.

A list of incorporated text-classifiers available for use can include the bag-of-words model, recurrent neural network models, and/or a wide range of the transformer and/or reformer-based models Available preprocessing techniques can use a mix of heuristic approaches involving proper noun detection, written number detection, beam searches, language models, and/or neural-net approaches.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 illustrates a simplified view of a system architecture.

FIG. 2 illustrates examples of steps for processing text.

FIG. 3 illustrates an example of combining two models.

FIG. 4 shows high-level operations modelled in a framework.

FIG. 5 represents several examples of classes.

FIG. 6 shows various commands that can be wrapped into a machine class.

FIG. 7 shows an ensembler in a machine framework.

FIG. 8 illustrates a process for adding new machines to an ensemble.

FIG. 9 shows an example of an ensemble tree structure.

FIG. 10 diagrams an example of an aggregator definition.

FIG. 11 shows a single ensemble for scoring text.

FIG. 12 illustrates examples of steps for hyperparameter tuning.

### DETAILED DESCRIPTION

A detailed explanation of the system, method, and exemplary embodiments of the present invention are described below. Exemplary embodiments described, shown, and/or disclosed herein are not intended to limit the claims, but rather, are intended to instruct one of ordinary skill in the art as to various aspects of the invention. Other embodiments can be practiced and/or implemented without departing from the scope and spirit of the claimed invention.

Challenges faced in natural language processing (NLP) are amongst the most difficult for machine learning. There is a need for a framework that uniquely dealt with text classification. Previous systems focused on a single neural network model for training in a silo type of architecture. And past work on neural network ensembles dealt with each neural network separately. While there have been attempts to improve on such work, they have not dealt with the heterogeneous ensemble of networks, nor have they deal with natural language processing models as contemplated and described herein.

In machine learning, a large quantity of data can be treated as a finite fixed set of features of real value. For example, images fit this category as each pixel can be considered a set of real values. Solutions can use linear and non-linear continuous functions to preprocess an image to some fixed number of pixels, allowing for a classification to be based on a finite fixed set of real values. Some frameworks can classify numeric data of this sort. A procedure is to normalize the data, then apply a nonlinear classifier on the finite set of features.

Text, however, is discretely valued (given by characters) and can be of an arbitrary length. The combination of those two characteristics can create challenges for frameworks. For example, tools for continuous domains (e.g., Generative Adversarial Networks, continuous transformations, etc.) have no natural or direct application to text. Accordingly, various tools for text tend to be unique to text, such as word-embeddings, spell-correction techniques, and phonetic tools, warranting an adequate framework to encapsulate.

Common elements and behaviors of different neural network models can be factored into a class object, called a machine. A preferred embodiment can include hardware, a software framework, and an application programming interface (API) that encapsulates implementation details of different machines and combinations of machines. The framework and architecture can be applied to the domain of natural language processing. The embodiment can present a simplified, high-level user interface (UI) to the user. The implementation of each solution has a range of options, and the framework can alleviate the requirement for a user implementing a particular solution to know the syntaxes required to implement those options. If required option values are not specified by the user, they can take on values known to have produced decent results.

Implementations can include general-purpose computers, processors, microprocessors, hardware and/or software accelerators, servers, and/or cloud-based technology (generically referred to herein as computers where context allows). The computer can have internal and/or external memory for storing data and programs such as an operating system (e.g., Linux, iOS, Windows 2000, Windows XP, Windows NT, OS/2, UNIX, etc.) and one or more application programs. Examples of application programs include computer programs implementing the techniques described herein, authoring applications (e.g., word processing programs, database programs, spreadsheet programs, simulation programs, and graphics programs) capable of generating documents or other electronic content, client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer, Google Chrome, Firefox, and Safari) capable of rendering standard Internet content and other content formatted according to standard protocols such as the Hypertext Transfer Protocol (HTTP), HTTP Secure, or Secure Hypertext Transfer Protocol.

The computers can include one or more central processing units (CPUs) for executing instructions in response to commands from executable code sent via communication devices for sending and receiving data. One example of the communication device can be an internal bus. Other examples include a modem, an antenna, a transceiver, a router, a dish, a communication card, a satellite dish, a microwave system, a network adapter, and/or other mechanisms capable of transmitting and/or receiving data, whether wired or wireless. In some embodiments, the processors can be graphics processing units (GPUs) or graphics accelerators. In preferred embodiments, tensor processing units (TPUs) are implemented. TPUs are relatively recent advancements originally designed for artificial intelligence accelerator application-specific integrated circuits (ASICs) developed by Google for neural network machine learning. The computers can also include input/output interfaces that enable wired and/or wireless connection to various peripheral devices. The peripheral devices can include a graphical user interface (GUI) and/or remote devices. A processor-based system of the computer can include a main memory, preferably random-access memory (RAM), or alternatively read-only memory (ROM), and can also include secondary memory, which can be any tangible computer-readable media. Tangible computer-readable medium memory can include, for example, hard disk drives, removable storage drives, flash-based storage systems, solid-state drives, floppy disk drives, magnetic tape drives, optical disk drives (e.g. Blu-Ray, DVD, CD drive), magnetic tapes, standalone RAM disks, etc. The removable storage drive can read from or write to a removable storage medium. As will be appreciated, the removable storage medium can include computer software and data.

In one example of an embodiment, there are two machine learning frameworks that can be utilized in this framework that is implemented in connection with the hardware: Keras with a backend of Tensorflow and Pytorch. Both frameworks can benefit greatly from accelerated methods, such as those offered by Nvidia's CUDA framework, which can be available on Nvidia graphics cards. While CUDA accelerated methods appear to be available on all cards made within the last decade or so, many cards also require more dedicated GPU memory than typically available on non-gaming PCs. Many consumer-grade entry-level graphics cards (such as GeForce GTX 1050 Ti, GeForce GTX 1060, or Quadro P2000) are equipped with two-gigabyte to six-gigabyte video memory capacity and can be utilized. In a preferred embodiment, however, the video card has at least eight gigabytes of video memory, optimally with sixteen or more gigabyte capacity. Available examples of video cards with sixteen gigabytes or more include the Quadro P/RTX 5000-8000 or V100, P40, Nvidia Titan RTX and GV100. Alternatively, embodiments can be implemented with cloud-based technology. For example, AWS instances of the following types can be utilized:

p2.x-Series: The p2.x-series ec2 instances carry Tesla K80 graphics cards with twelve gigabytes of video memory. This can be sufficient for most tasks.

p3.x-Series: The p3.x-series ec2 instances carry Tesla V100 graphics cards with sixteen gigabytes of video memory. Bigger tasks are optimally utilized on P3.

These two types of instances can offer a level well above the bare minimum. When using models that benefit from pretraining, ample hard-disk space (or other memory discussed above) can be required to store the models.

FIG. 1 illustrates a simplified view of a system architecture including a framework (101). The exemplary framework illustrated has been implemented as a model abstraction layer between a user interface (102) and an ensemble of neural networks. The user interface can be a common interface for multiple, heterogeneous sets of neural network models.

The framework can be an abstraction that offers core functionality and that can allow efficient implementation of additional use-specific functionality. In a sense, the framework can provide a universal, reusable core for implementing and/or deploying applications that are part of a larger platform. The framework can support programs, compilers, code libraries, tool sets, and/or application programming interfaces (APIs). Advantageously, the framework (101) can abstract neural network model specific training mechanisms and hyperparameter formats, both of which are described further herein. The framework can allow dynamic additions of new neural network models with, for example, the addition of model-dependent wrappers. While clear from context to the skilled artisan, it should be noted for the avoidance of doubt that the term “abstract” (and variants such as “abstraction”) refers to the computer science term and not to an abstract thing or idea in the common sense.

Sitting between the user interface and the ensemble of neural network models, the framework can advantageously abstract differences in training APIs of various types of NLP-focused neural networks. This can allow nonskilled artisans (for example, non-data science practitioners or nonexpert data scientists) to train sophisticated models, and it can also provide a common training environment for different natural language processing models.

Frameworks described herein confer many advantages. For example, models can be quickly added to and removed from the ensemble to maximize the overall accuracy of the ensemble. The framework can significantly ease the addition and combination of an unlimited heterogeneous set of NLP models. This can allow the user to quickly iterate over the different combinations of heterogenous NLP models to obtain higher accuracy results. Also, the framework can facilitate training of a group of neural networks (NN) models (an ensemble) through a common interface that hides the model specific details from the user. This dramatically decreases the time to code experiments and products.

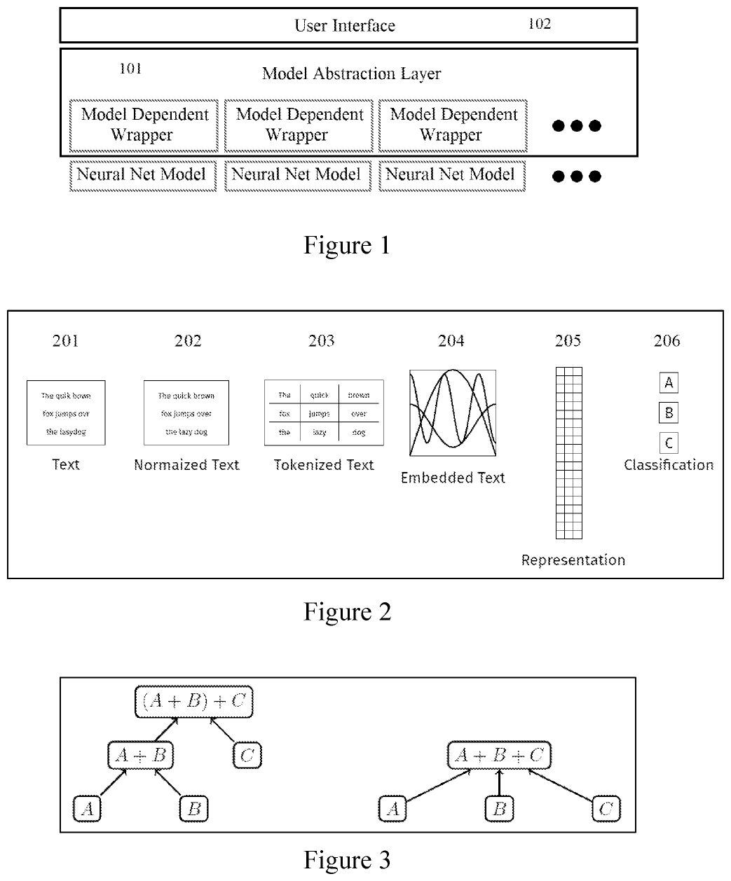

Embodiments can include an automated text scoring framework. A procedure for natural language processing of text can be distinctive from procedures for other data. An example of a procedure for text is shown in FIG. 2. The procedure can involve cleaning and normalization, tokenization, embedding, the representation of a sequence as a finite set of features and classification.

As illustrated in FIG. 2, raw text (201) can be input. Such text can require some level of cleaning. This can involve simpler applications of regular expressions—such as those required to remove html—to more sophisticated methods—such as correcting spelling. The text can be normalized (202). Text normalization has many facets within the context of NLP. Normalization can include optical character recognition (OCR) and/or manipulation of text to improve processing, such as converting all letters to lower case. It can include spell corrections, which can account for context. Normalization can include accounting for phonetics, the recognition of named entities, and/or incorrectly used real words.

Tokenization (203) can be utilized to identify what constitutes a word in the target language. Various steps and text types can be utilized to create discrete tokens of text representing words. For example, whitespace connote word boundaries in text. Punctuation marks can also be utilized in tokenization, for example to identify abbreviated words. Hyphens, en dashes, and em dashes can be utilized. Because those three punctuation marks are often inconsistently used and their sizes can vary across font types, additional analysis and/or context can be utilized to draw a full meaning. For example, a dash between two numbers can imply a range, and an en dash can be presumed, whereas a dash located at the far right of text but found in a string of letters can imply a hyphenated word.

An NLP process can include word embedding (204) to determine the meaning of a tokenized word. Word embedding can include a mapping from words to some continuous space. The embedded text can be considered to be a signal of arbitrary length. Any such signal can be represented by a fixed dimensional vector (205). The resulting representations can be classified as a fixed set of real valued features (206).

While there are many intricacies in natural language processing that differentiate it from other fields in machine learning, some principals of applying a machine-learning solution to a classification problem can be similar or even the same. For example, a data set can be divided into a training set, a test set, and a validation set. The solution to a training set can be fit in a manner that maximizes a metric on the test set. The statistics found on validation can be reported. Productions can be loaded and saved. Although some principals can be similar, the skilled data scientist should have in-depth knowledge of the library that the solution was written with in order to complete each step. A collection of heterogeneous models can be presented by a uniform application programming interface (API) by, for example, utilizing an abstract class that wraps and/or encapsulates the process.

A framework can be implemented with a set of libraries and/or files. Such libraries and files can include open source tools. For example, the h5py package is available from GitHub and can provide a Pythonic interface to the HDFS binary data format. Other libraries can be utilized include absl-py, astor, beautifulsoup4, blis, boto, boto3, botocore, bs4, cachetools, certifi, cffi, chardet, Click, cymem, docutils, en-core-web-sm, gast, gensim, google-auth, google-auth-oauthlib, google-pasta, grpcio, idna, importlibmetadata, jmespath, joblib, Keras, Keras-Applications, Keras-Preprocessing, language-check, logger, Markdown, more-itertools, murmurhash, numpy, oauthlib, opt-einsum, pandas, plac, preshed, protobuf, pyasnl, pyasnl-modules, pycparser, python-dateutil, pytorch-transformers, pytz, PyYAML, regex, requests, requests-oauthlib, rsa, s3transfer, sacremoses, scikit-learn, scipy, sentencepiece, six, smart-open, soupsieve, spacy, srsly, tensorboard, tensorflow, tensorflow-estimator, termcolor, thinc, torch, tqdm, Unidecode, urllib3, wasabi, Werkzeug, wincertstore, word2number, wrapt, and zipp.

Models can be saved and/or loaded. Each machine can be saved to a path with a file named such as “config.json.” In a preferred embodiment, the config files can each include at least three variables: itemid, bankid and max_scores. The itemid and bankid can be sufficient to uniquely define the data. The max_scores variable can define the machine's scoring dimensions. Machines can contain a machine configuration, which can specify the parameters defining the variant of the model used. These variables are further described herein. An example of a manner for creating an instance is the following:

```
from trainer.machines import EssayBERT
Steve = EssayBERT({
  “itemid”: 21564,
  “bankid”: 100,
  “max_scores”: {“FinalScore”: 3}})
```

Other information that the machine requires to function can be appended to the configuration, and machine_config with default values can be stored in the machine's default_machine_configuration module. The configuration and any necessary data (such as weights, classifiers, text, etc.) can be saved when calling a machine's save command. The saving of a machine can include a path to a folder. Such a folder can be associated with that machine and saving another machine can overwrites the machine saved at that folder.

Any machine can be loaded using the Machine module. The Machine module has several ways to instantiate a machine. A useful way can be a machine_from_path function in the Machine module. As an example, it can be called as follows:

from trainer.machines.machine import Machine
Steve = Machine.machine_from_path(path, autoload=True)

The path can be replaced with a valid path for a machine. The autoload parameter can be passed to run each machine's individual load function which can load any auxiliary models, weights, or classifiers the particular machine needs to run.

A major advantage of frameworks described herein is the ability to combine the results of machines in an almost arbitrary manner. If A and B are two machines, and if f is a metric to optimize, then in a sense, the metric can be maximized over the linear combinations of the outputs of machine A and B. The maximum can be expressed as:

$${max}_{α , β} f ( α A + β B ) \geq max ( f ( A ) , f ( B ) )$$

The maximum over all α and β is greater than the particular cases α=1,0 and β=0,1. The logistic regression of the outputs is at least as good as the best performing model, where in practice, the results often far exceed both models. If machine A and B agree all the time, no gains are made. But the more they disagree, the greater scope for the linear combination to add value. The heterogeneity of the models can be combined to positively impact maximal achieved metrics.

FIG. 3 illustrates an example of combining two models, then a third on the left, and a way of combining three models in one ensemble on the right. By allowing the combination of machines to be a machine itself, combinations can be endowed with a structure. For example, given machines A, B, and C, two machines can be combined, and then that machine can be combined with another (in three different ways). Alternatively, A, B, and C can be combined as a straight-linear combination in one way, as shown in FIG. 3. An advantage of this is that it can endow a user with the ability to easily consider four different ways of combining three models. An end metric is not only as good as the worst model, maximizing over the structure of ensembles can further increase metrics in a manner not previously achievable. Because ensembles can have the same interface as the machines, ensembles can be fit, loaded, saved, and validated like any other machine.

The framework can provide automation to many of the tasks required to bring a model to production. Tasks like confidence modelling, model testing and verification, hyperparameter tuning and other forms of analysis can be built into the framework.

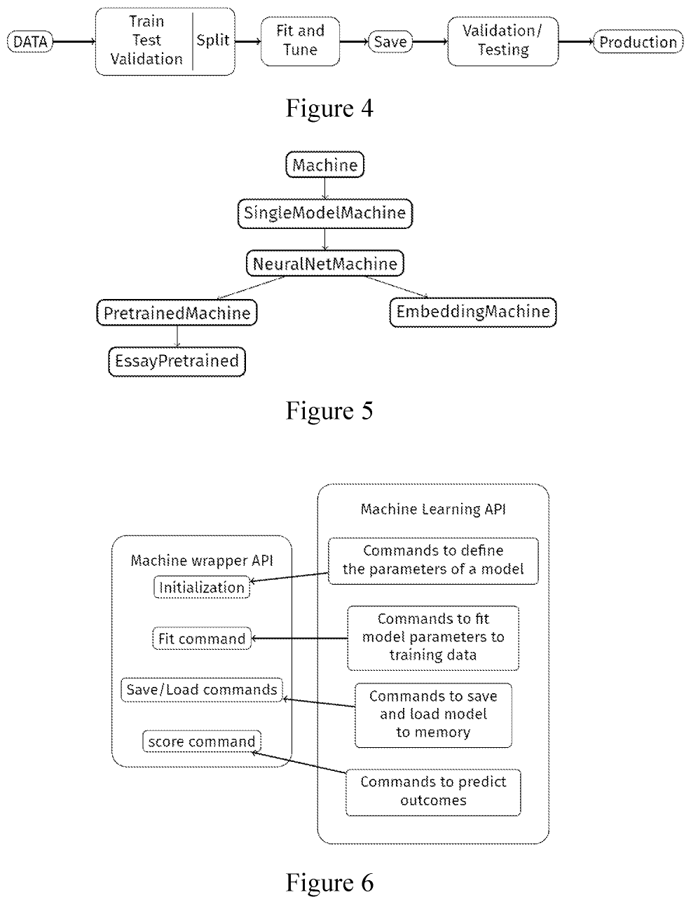

FIG. 4 depicts high-level operations modelled in a framework. A solution can start with initial data. A second stage can be dividing the data into an appropriate training set, test set and validation set. A third stage, “fit and tune,” can include fitting data with a machine learning solution. Hyperparameter tuning can be performed in a unified way across some or all of the different types of neural network models in the ensemble. This can significantly reduce the many years of experience, deep knowledge of the intricacies and training APIs, and hours of hard-coded procedures for each hyperparameter of the models. Although illustrated as the fourth stage, an optional ability to save can be implemented wherever necessary or preferred, the advantages of which is made clear below. Validation and/or a test of performance can be conducted. The solution can be deployed in a production system.

The implementation of each solution can have a range of options, for example from higher-level options like the way in which text is prepossessed, to lower-level options like the particular non-linear functions used as activation functions. A dictionary of options can be beneficial for the process. Influential options available can be prioritized. Advantageously, implementing solutions can be done without knowing the particular syntaxes of the API that are required to implement those options.

Each machine that possesses a machine_config can also have a set of default parameters that can be assigned to the machine_config if not already set. These values can be chosen generically with prior knowledge of what has worked in the past. This can allow specification of as few or as many hyperparameters as preferred by specifying only those values desired. For example, an instance of EssayBERT with 5 layers and a batch size of 10 can be created using the command:

```
from trainer.machines import EssayBERT
Steve = EssayBERT(
  {‘itemid’:0,
    ‘bankid’:0,
    ‘max_scores’:{FinalScore’:3},
    ‘machine_config’:{‘transformer_layers’:5,
      ‘batch_size’:10}})
```

In a preferred embodiment, hyperparameters can be trained and can control the operation of the machines, each of which can have its own data model to be trained. In some contexts, it can be sufficient to save a best result for each parameter configuration. Often, however, a single best result will not be sufficiently robust for analyzing different data sets. Accordingly, it can be advantageous to save the top several results, for example, the three best or the five best results. The tradeoffs between utilizing a single best result and utilizing a number of top results can factored for specific implementations and analyses. Hyperparameters can be considered analogous to switches or knobs of a system, in the sense that a data scientist can override or ignore trained hyperparameters configurations, for example based on past experience and/or preference. Several examples of parameters are described below.

attention_masking: This is either True or False, and corresponds to whether the attention weights should be over the full input or a mask, which is an array of 0s and 1s.

batch_size: This parameter can be used in training. It can be used to determine how many batches are fed into the training regime at any iteration of the optimization step.

entropy: This is the type of entropy loss function, which typically is either binary or categorical.

hidden_dimension: This refers to an internal number of features in a layer of the neural network, related to the number of dimensions preferred. This determines the number of units in a layer of transformers.

learning_rate: This is the learning rate for the optimizer that can be used in any of the neural network models.

layer_units: In the context of recurrent layers of LSTM units or GRUs, this variable can be used to specify how many such units are in a layer.

max_length: This variable can be used to invoke a cap on the maximal number of tokens for the input.

overlap_token_stride: When wrapping training responses over max_size, this variable can be utilized for the number of overlapping tokens between one training data and an appended piece of training data.

pretrained_model: For pretrained models, this can identify the type of model architecture for training. This can be one of the specific pretrained models for the class called.

train_wrap: This is True or False and can govern how training data is handled beyond max_size. For example, if False, the training data can be cropped. If True, the training data can be appended to include the tokens that go beyond max_size as a new piece of training data.

transformer_layers: Within transformer-based architectures, this can be utilized for layers of transformers. For example, in pretrained models, this can be an integer between 1 and 24.

If options are not specified by a user, they can take on values known to have produced acceptable results. A list of the default parameter examples is provided in Table I. If a new solution appears, by wrapping that solution in a machine, any person utilizing the framework should be able to use and experiment with that solution without knowing the particular API it was written with. In this sense, the framework seeks to democratize sophisticated NLP models.

TABLE I

| Machine Type | Machine Config Default Parameters |
|---|---|
| EssayBERT | transformer_layers = 10, learning_rate = 5e−6, |
| | attention_masking = True, entropy = ‘categorical’, |
| | pretrained_model = ‘bert-base-uncased’, batch_size = |
| | 5, max_length = 510, overlap_token_stride = 50, |
| | train_wrap = True |
| EssayRoBERTa | transformer_layers = 10, learning_rate = 5e−6, |
| | attention_masking = True, entropy = ‘categorical’, |
| | pretrained_model = ‘bert-base-uncased’, batch_size = |
| | 5, max_length = 510, overlap_token_stride = 50, |
| | train_wrap = True |
| EssayDistBERT | transformer_layers = 10, learning_rate = 5e−6, |
| | attention_masking = True, entropy = ‘categorical’, |
| | pretrained_model = ‘bert-base-uncased’, batch_size = |
| | 5, max_length = 510, overlap_token_stride = 50, |
| | train_wrap = True |
| EssayXLM | transformer_layers = 10, learning_rate = 5e−6, |
| | attention_masking = True, entropy - ‘categorical’, |
| | pretrained_model = ‘bert-base-uncased’, batch_size = |
| | 5, max_length = 510, overlap_token_stride = 50, |
| | train_wrap = True |
| RubricBERT | transformer_layers = 4, learning_rate = 5e−6, |
| | attention_masking = True, entropy = ‘binary’, |
| | pretrained_model = ‘bert-base-uncased’, batch_size = |
| | 5, max_length = 510, overlap_token_stride = 50, |
| | train_wrap = True |
| RubricRoBERTa | transformer_layers = 3, learning_rate = 5e−6, |
| | attention_masking = True, entropy = ‘binary’, |
| | pretrained_model = ‘bert-base-uncased’, batch_size = |
| | 5, max_length = 510, overlap_token_stride = 50, |
| | train_wrap = True |
| RubricDistBERT | transformer_layers = 4, learning_rate = 5e−6, |
| | attention_masking = True, entropy = ‘binary’, |
| | pretrained_model = ‘bert-base-uncased’, batch_size = |
| | 5, max_length = 510, overlap_token_stride = 50, |
| | train_wrap = True |
| RubricXLM | transformer_layers = 4, learning_rate = 5e−6, |
| | attention_masking = True, entropy = ‘binary’, |
| | pretrained_model = ‘bert-base-uncased’, batch_size = |
| | 5, max_length = 510, overlap_token_stride = 50, |
| | train_wrap - True |
| PytorchRNN | embedding dimension = 200, hidden dimension = 200, |
| | dropout: 0.1, layers = 2, max_length = 1000, |
| | batch_size = 50, entropy = ‘binary’ |
| RubricLSTM | embedding dimension = 200, layer units = 32, |
| | dropout: 0.2, layers = 2, max_length = 1000, |
| | batch_size = 50, entropy = ‘binary’ |

As discussed above, the machines can be abstract classes or instances of classes, i.e. objects, which confers benefits of encapsulation, composition, inheritance, delegation, and many others. A preferred architecture can uniformize the standard ways in which a component of a scoring engine is integrated. Instead of writing specialized code for each type of component, a coding standard can be enforced, which each component must adhere to. An advantage of this coding practice is that adding and/or subtracting an arbitrary number of components can be accomplished in a uniform manner without the addition of specialized code.

FIG. 5 illustrates several abstract classes that can inherit from the Machine class. The SingleModelMachine can encapsulate models dependent on one neural network or another single machine learning classifier. The NeuralNetMachine can embody machines that use, for example, an underlying TensorFlow or PyTorch neural network model. The EmbeddingMachine can be utilized for classes in which the embedding for the neural networks are separated from the weight matrices. This can allow the embeddings to be handled externally by an embedding manager (not depicted). The PretrainedMachine can wrap a broad class of pretrained language models. The EssayPretrained can include specific functionality optimized for single scores found in essay scoring rubrics. A list of example instances and their inheritances is provided in Table 2.

TABLE 2

| Class | Instances |
|---|---|
| Machine | Ensembler, Aggregator |
| SingleModelMachine | Bag-of-Words |
| Embedding Machine | RubricLSTM, PytorchRNN |
| PretrainedMachine | RubricBERT, RubricXLNet, RubricRoBERTa, |
| | RubricDistilBERT, RubricALBERT, |
| | RubricXLM |
| EssayPretrainedMachine | EssayBERT, EssayXLNet, EssayRoBERTa, |
| | EssayDistilBERT, EssayALBERT, EssayXLM |

The instances can be understood to be available machines and/or wrapped NLP machine learning classifiers. The instances are described in exemplary terms below.

Bag-of-Words: A model based on the Latent Semantic Analysis (LSA) of a term frequency-inverse document frequency (tf-idf) representation of a document with additional hand-crafted features. These features can be fed into a linear classifier to form a score.

BERT: The Bidirectional Encoder Representations from Transformers (BERT) engine is a transformer based masked language model. There are multiple versions. For example, EssayBERT is BERT optimized for single scores. RubricBERT is designed for multiple scores.

xLNet: An advance on the BERT engine is a model that can resolve the inter-dependency of predicted words by averaging over permutations of the order in which the words are predicted.

RoBERTa: Robustly-Trained BERT can be achieved by removing a next sentence prediction aspect of the BERT training and trains the BERT engine for many more epochs.

DistilledBERT: A distilled version of the BERT engine built with fewer layers. Although a smaller version of BERT, the distilled engine can perform well in many key benchmarks.

LSTM: Long-Short-Term-Memory unit, a staple concept in neural network design. In preferred embodiments, however, the LSTM can be modified from conventional architectures. For example, two layers of bidirectional recurrent units can be implemented with an attention mechanism both at the token level and the target level.

Block LSTM: A further modification from conventional LSTM. A document can be segmented into blocks that are fed into an LSTM. The output from the blocks can then be fed into another LSTM. This architecture can mitigate challenges from long-term dependencies by, for example, dividing the distance between key terms by the block size.

Ensembler and Aggregator: These machines can wrap the processes of combining a collection of machines. The ensembler can fit a logistic regression classifier to the output of a collection of machines to a set of targets in a test set. Aggregators can build confidence models for each dimension and all the other characteristics that one would want from a production-ready system.

The machine class can be further extended in many ways. For example, the above list of examples can be augmented by adding Reformer-based architectures, Longformers, and multi-headed attention models.

A machine can be considered as a fundamental computational unit. By way of specific example, input and output of a machine can be defined by specifying itemid, bankid, and max_scores, where:

itemid is an int identifier for the item within a bank;

bankid is an int identifier for where the responses came from; and

max_scores is a dict of integers indicating the maximal score.

The itemid and a bankid can be necessary and sufficient to determine the types of input the machine expects. In other words, all responses should be for the same prompt. Because there can be multiple dimensions, a response can be assessed, the max_scores attribute can determine which components of the scoring rubric the particular machine was designed to assess.

There are some functions that all machines preferably have, for example the ability to score, save, load, and output. This can be enforced by letting the machine be an abstract class with four fundamental functions:

score (text: str)→dict. This function sends a str, a student response, to a score for each key in max scores between 0 and the dict entry.

output (text: str)→np.array. This sends a student response to an array of outputs of some length.

save (path: str). This function saves the relevant information required to save the machine to a directory.

load (path: str). This function takes the information stored in a path and recreates the object stored in that path.

The framework can be specifically designed with combining models in mind, in which case, the scoring function need not be called directly. It, however, can be beneficial to assess each machine independently. The ability to check whether each machine of a given system is working properly can be useful for knowing what models are contributing more significantly to a given result. In the context of ensembling, the worst performing model can be dropped and/or models can be added from a collection of models that are individually performing well. And for a new scoring model that proves useful, the commands that are required can be wrapped into the machine class for use through the APIs to use it (see for example FIG. 6). In this way, the API can easily be updated to incorporate existing models or any new models that may appear in the future. The framework can include the following modules: common, util, and trainer. The common module is a collection of tools focused on configuration parameters, file-handling, logging, preprocessing, spell-correction, normalization, and reporting. The util module contains tools for testing and installation. The trainer contains the machine class and a collection of embodiments of stated machine class and subclasses thereof, a collection of tools in common to machines, and a suite of hyperparameter-tuning tools.

Various techniques and routines can be utilized in training, ensembling, and aggregation. The output and scoring of text can operate on strings. For any score, one can expect to have a well-defined response to score and associated scores for various dimensions. The functionality for handling such data is well-suited to the data frame framework. Data frames can facilitate reading from either excel, pickled format, or csv files in which the resulting data frame has named columns in addition to indexes that reference rows of data.

Requirements can be placed on the data frame. For example, each dimension listed in the machine variable max_scores can be a column of the data frame. If, for example, the max_score variable were to be given by {conventions: 2, elaboration: 4, organization: 4}, then at a minimum the data used to train the machine would be of the form in Table 3. [at a minimum the data used to score would be . . . they are not necessarily the maximum]

TABLE 3

| Text | Conventions | Elaboration | Organization |
|---|---|---|---|
| Some text to score | 1 | 2 | 3 |
| Other text | 1 | 1 | 1 |
| . . . | . . . | . . . | . . . |

The fit command can utilize a Pandas Series containing the training and test text and a training and test data frame with at least each of the max_score dimensions as a column. A validation dataset requirement can be enforced, such as for reporting accurate accuracy and QWK.

Configurations can require a collection of labelled data, D, which has been labelled for multiple dimensions (d₁, . . . d_{M}, and a collection of unlabeled data, U. Our aim is to define a complete model.

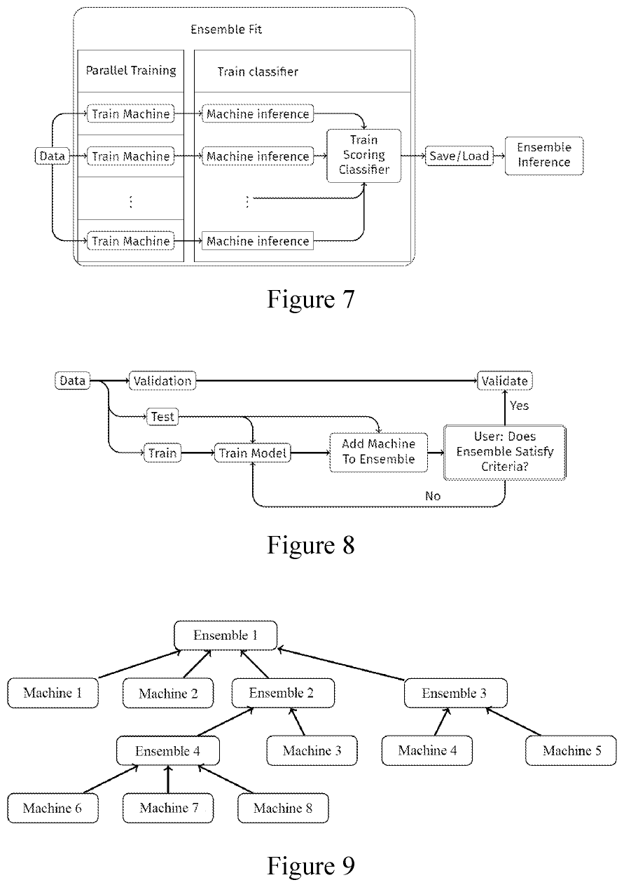

FIG. 7 illustrates how an ensembler can fit into a machine framework, such as the one illustrated in FIG. 4. The data part of the diagram describes the split of the data into training, testing, and validation sets, as per FIG. 2. The Ensemble fit command, shown by the large rectangle encapsulates subprocesses that train each of the machines in the ensemblers list of machines. This means that each machine has been fit independently to a data set, then the Ensembler accesses the machines inference interface to determine what the output of the machines would be on a test set. This output can be used to fit a low-dimensional classifier (e.g., logistic regression) to the test data. The saving and loading module iteratively can utilize the saving and/or loading interface for the machines within its machine list to make a complete copy of all the machines it uses onto the disk or into memory, which means that this definition of saving may be recursively defined. The Ensemble interface extends the machine interface in that it allows the ensembler to report statistics on the individual machines and gives a measure of the confidence based on the accuracy statistics of the low-dimensional classifier on the test set.

In a setup, an ensembler can be instantiated like every other machine, but it possesses some functions that are unique to the ensembler. Assuming a list of machines, M, with names in a list, names, the ensembler can be instantiated with the list added as follows.

```
Greg = Ensembler({‘itemid’:0, ‘bankid’:0})
for machine, name in zip(M,names):
  Greg.add_machine(M, name)
    Greg.fit(train[‘text], train, test[‘text’],
    test, train_machines= False)
```

If train_machines is set to true, then the ensembler can train each machine in an automated manner, as well as fit classifiers to each score. In this way, everything from the creation to the training can be automated at once. There are benefits, however, to break up the procedure to make sure that every machine being ensembled adheres to some standards as the addition of machines may not always produce desired gains, especially in cases in which the machine has been overfit to a set of training data.

In some embodiments, it can be assumed that for each score being produced, there is a single ensemble. The converse, however, is not necessarily true. For example, there can be multiple scores reported by one ensemble. There can be checks in place to ensure that this coding practice is adhered to. One aim of the ensembler can be to use all available machines to predict each score. In such a system configuration, the output of machines trained on one score may be used as input in the calculation of another score. For example, an ensembler can report a score of “Elaboration” and “Organization”; but because these scores are often highly correlated, it may be preferred that their calculations be based on a common set of features. It can be just as easy to have them calculated independently, however, this is a choice left to the user.

The following steps can be taken to obtain a complete model.

1. Define a training set and a validation set from D.

2. Define test samples from the training set for each ensembler, E₁, . . . Eₖ.

3. For each ensembler, train m₁, m₂, . . . mₙ on the complement of the test sample in the training set, maximizing QWK on the test set.

4. Fit each the ensembler to its test set.

5. Add all ensemblers to an aggregatorA, which is fit to the validation data and the unscored data.

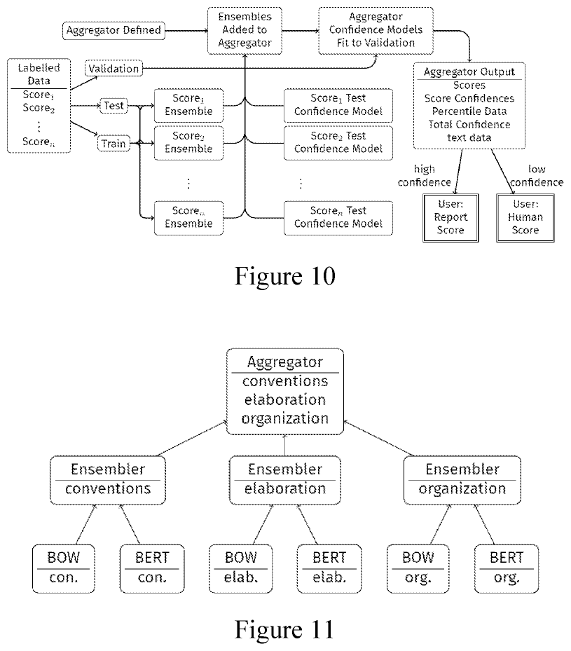

Once an ensemble is formed, a user can decide whether the machine satisfies any performance constraints. Computational load can also be an important consideration. If the machine is performing adequately, a user can consider whether to remove some machines from the ensemble to reduce computational load of one or more of the machines and/or reduce processing time. If the ensembled machine is not performing adequately, the user can add new machines and/or an ensemble with another machine, which itself can be the ensemble of a collection of machines. Purely adding machines to an ensemble is illustrated in FIG. 9. It should be noted that the flexibility in the structure of an ensemble allows for a great variety of ways to combine a selection of machines. One such possibility is depicted in FIG. 10.

In some embodiments, aggregator level requirements can be enforced. For example, for each dimension in its max scores, there can be precisely one ensembler that reports that dimension. As another example, each ensembler can score a subset of the aggregators max_score dimensions. For the essay questions, a fixed structure can be utilized, for example, one that includes ten machines. A diagrammatic way of considering the relationship is depicted FIG. 10.

FIG. 8 illustrates a process by which new machines can be added to an ensemble to achieve a desired accuracy. Data can be input and split between Validation, Test, and Train paths. Train Model represents the process of creating a machine and training it using a training set and a test set. Add Machine to Ensemble box represents a section of the ensembler interface that can allow adding machines to an ensemble and/or the ability to train that ensemble. Once the performance is evaluated, it can be determined whether the performance meets appropriate standards for deployment. If so, the model can be validated (knowing that validation can show different performance from test). If the performance is poor, more machines can be trained to improve the performance.

FIG. 9 revisits the concept of FIG. 3 by illustrating a possible alternative ensembling tree structure to a simple ensemble of several machines. Here, each machine (Machine 1 through Machine 8) can be a stand-alone classifier. The ensemble can be a classifier built upon stand-alone classifiers. A classifier can create classes (groups). A classifier can output single category and/or groups in order of more likely to less likely to be correct. Output can be used to learn and/or train. Generally, more learning can lead greater accuracies and can be utilized as a factor when aiming for the highest possible accuracy.

FIG. 10 an example of a definition of an aggregator. The figure illustrates how ensemblers can fit into the greater framework of the scoring system. The aggregator module shows how confidence can be measured using the validation set. For a dataset that contains multiple scores, this figure shows how each score can be assigned to an ensembler, which can be trained in accordance with FIG. 3 and more specifically FIG. 8. Each ensembler machine and the machines within the ensemblers can be trained on training data with a train-test split. The ensembler can be fitted to the test set incorporating a measure of confidence on the test set, shown by the difference confidence models. These confidence models and the ensemblers can all be part of the aggregation of models to give a full set of scores, a level of confidence for each score, and a final confidence. Typically, the Validate, Test, and Train modules would not process data in parallel, but the skilled artisan would appreciate the advantages of parallel processing for various situations. Of note is that in cases where the aggregator's confidence scores are below a threshold score, a user can intervene. In cases where confidence is below a preferred threshold, the user's analysis can be used for reporting and can also be used to determine when a human is required for hand scoring. The human score (which in this case is the score actually “reported” to end-user) can be manually entered to the system for further training. Then, machine can try again and assess the new results.

FIG. 11 depicts one of the more typical situations where each essay is given three scores: a conventions score based on writing style; an organization score based on the structure of the essay; and an elaboration score based on the semantic content of the essay. The figure depicts a single ensemble for each of the scores where each ensemble draws inference from a BERT model and a Bag-of-Words (BOW) model. The aggregator can assign three scores to each essay based on the output of its three ensemblers.

A distinct advantage of some embodiments is hyperparameter tuning. A grid search can be implemented by specifying the parameters in the machine configuration to be specific values. The number of trials is the product of the number of values to be checked for each parameter. The number of trails can increase exponentially with the number of parameters. The grid-search function can be specified by the following definition:

def grid_search(config, machine_type, parameters, path, n_best)

The parameters are specified by a list of tuples, the first element is a string corresponding to the key in the machine config while the second element is a list of the elements that parameter may take. For example, in the above example we have

grid_search(config = {‘itemid’:31604, ‘bankid’:0,
‘max_scores’:{‘conventions_final_score’:2}},‘RubricBERT’,
parameters = [(‘learning_rate’, [1e−6, 2.5e−6, .5e−5])),
(‘transformer_layers',[9,11]),(‘batch_size’, [3,10])],
path = “c:/models/31604/conventions”,n_best = 4)

This method will iterate over the twelve possible combinations of choices saving the best four models and a record of the performance of the models in the paths. More generally, the iterator can be replaced with a Bayesian process of choosing hyperparameters in which case there is interaction between the control module and the output of the machines.

Various preprocessing options can be implemented. Preprocessing options can be added, for example, to a grid search. This can facilitate iteration over preprocessing options to maximize given metrics. As an example, the following can be preprocessing options:

Lower: An option that can convert all tokens to lower case.

Spell-checking: Can have various options. For example, a None option can simply omit spell-correction. A LanguageTool option can be implemented to correct misspellings. A WordTree option can be a memory and computationally efficient version of Norvig class spell-correction. It can encode a vocabulary using, for example, a tree structure allowing for efficient recursive searching. A KN-Metaphonic-Wordtree option can be a beam search method, for example, one where the wordtree method can be combined with real-word error correction, part-of-speech tagging, a tool that measures phonetic Levenstein edit distance on the output of a double metaphone algorithm, a context-specific Kneser-Ney smoothing language model, and/or a general language modified Kneser-Ney smoothing method built on a sufficiently large corpus. WordTree and KN-Metaphoneic-WordTree can be developed specifically for the framework.

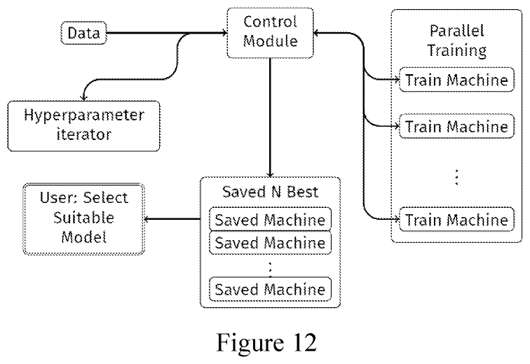

FIG. 12 depicts an example of how hyperparameter tuning can be performed. This figure generalizes the training procedure to accommodate a range of values for the parameters defining the model. This figure can apply to both grid-search methods and Bayesian approaches to hyperparameter tuning. A governing of a control module can be coded. The control module can rely on a fixed set of data and a hyperparameter iterator. The control module can take a set of hyperparameters, which can include model parameters and/or preprocessing steps. The control module can train machines on those hyperparameters. The resulting trained machine can be used to inform the control module as to whether it is one of the best performing machines out of the set of machines. It can also inform what the control module sends to the hyperparameter iterator. The results of training can inform the subsequent choices of hyperparameters, for example in the case of Bayesian methods. All models can be saved. A user can then decide which models have the most desirable performance characteristics and/or accuracy statistics.

For illustrative purposes, provided below is a coded example—taking an ensemble of two models, a BERT model with four layers and an XLNet model with six layers.

```
import pandas as pd
from trainer.machines import EssayBERT, EssayXLNet, Ensembler
from sklearn.model_selection import train_test_split
data = pd.read_excel(“essay_data.xlsx”)
train_data, val = test_train_split(data, test_size = 0.15)
train, test = train_test_split(train_data, test_size = 0.2)
max_scores = {‘conventions’:2}
steve = EssayBERT({‘itemid’:0, ‘bankid’:0,
  ‘max_scores’:max_scores,
  ‘machine_config’:{‘transformer_layers’:4}})
chris = EssayXLNet({‘itemid’:0, ‘bankid’:0,
  ‘max_scores’:max_scores,
  ‘machine_config’:{‘transformer_layers’:6}})
steve.fit(train[‘text’],train,test[‘text’],test)
chris.fit(train[‘text’], train, test[‘text’],test)
john = Ensembler({‘itemid’:0, ‘bankid’:0,
  ‘max_scores’:max_scores})
john.add(steve,‘steve’)
john.add(chris,‘chris’)
john.fit(train[‘text’], train, test[‘text’],test)
print(john.test(val[‘text’], val))
paul = Aggregator({‘itemid’:0, ‘bankid’:0,
  ‘max_scores’:max_scores})
paul.set_ensembler(john, ‘john’)
paul.save(“model_path”)
```

The models can be individually fit to the data. The linear combination of the outputs of the machines can be fit to the test data. These can be saved. The results can be tested. Doing so can test the results of each individual component of the ensemble on the validation set in addition to the ensemble.

The framework can accommodate new machine learning models and neural network architectures. An advantage can be that flexibility and standardization of implementation, primarily requiring only the writing of wrappers. This also adds to the span of relevancy of the framework. This is important in the field of machine learning given that it is a rapidly evolving technology. By distilling the key features of text-classification models into one abstract class, the framework can be extended to incorporate future models with an appropriate wrapper. This will enable any user who is familiar with the framework to use the latest machine learning/neural network models in a variety of languages when a wrapper is made available. As discussed more fully herein, the list of incorporated text-classifiers available for use can include the bag-of-words model, recurrent neural network models, and a wide range of the latest transformer and reformer-based models. The framework can also simplify development with GPU and TPU architectures. This enables users to experience accelerated training speeds with no additional coding requirements.

Preferred embodiments can include a unique software framework for use by non-experts that simplifies the development and deployment process of a wide range of text-classifiers. The framework can be specifically and uniquely designed to automate the usual preprocessing, normalization, tokenization, and embedding processes involved in both training and inference so that the user need only deal with raw text input.

As discussed further herein, embodiments can abstract away differences in the development and deployment of a wide variety of heterogeneous classical and neural network-based classifiers. Each classifier can be configured to admit just five commands associated with instantiation, training, saving/loading, and inference. This simplifies text-classification in a way in which almost all the choices available to an expert in the field is provided in the instantiation step in a uniform while allowing non-experts to quickly and easily experiment with very sophisticated variations of available models. The suite of tools can allow iterating and tuning hyperparameters—such as learning rates, dropouts, and normalization constants, in addition to non-traditional hyperparameters, such as parameters associated with preprocessing methods—in one interface.

The software framework can take a unique approach to ensembling a collection of text-classifiers allowing non-experts to easily ensemble collections of heterogenous models in a way not previously taken within the machine learning community. The framework allows non-experts to seamlessly add and remove models in an ensemble to meet either accuracy or compute-time requirements. The framework can be built so that ensembles can be deployed as easily as any other model.

A framework for ensembles of text classifiers can be combined with confidence models and can report both a score and a measure of how confident the model is of that score. This can give the user the option to review scores of which the model is not sufficiently confident. Preprocessing techniques can use a mix of heuristic approaches involving proper noun detection, written number detection, beam searches, language models, and neural-net approaches.

All of the systems and methods disclosed and claimed herein can be made and executed without undue experimentation in light of the present disclosure. While the apparatus and methods of this invention have been described in terms of preferred embodiments, it will be apparent to skilled artisans that variations may be applied to the methods and in the steps or in the sequence of steps of the method described herein without departing from the concept, spirit and scope, or the invention. In addition, from the foregoing it will be seen that this invention is one well adapted to attain all the ends and objects set forth above, together with other advantages. It will be understood that certain features and sub-combinations are of utility and may be employed without reference to other features and sub-combinations. This is contemplated and within the scope of the appended claims. All such similar substitutes and modifications apparent to skilled artisans are deemed to be within the spirit and scope of the invention as defined by the appended claims.

1. A natural language processor comprising:
a memory having executable software code;
a processor for implementing commands of the executable software code;
the executable software code comprising a software framework and an application programming interface, wherein the application programming interface encapsulates a collection of natural language classifiers; and
wherein the natural language processor is configured to receive raw text.

2. The natural language processor of claim 1, wherein the executable software code includes commands to direct the processor to normalize the raw text into normalized text, to tokenize the normalized text into a collection of tokens, to map the collection of tokens into a finite dimensional real vector space of features, and to classify the finite dimensional real vector space to approximate a set of training data based on a collection of parameters.

3. The natural language processor of claim 1, wherein the processor and the executable software code are configured to normalize the raw text, to map each of tokens to a finite dimensional vector space via a word-embedding, which is then processed by a neural network to map the collection of tokens to a fixed dimensional real vector space of features, which is classified.

4. The natural language processor of claim 1, wherein the application programming interface includes:
an initialization command that defines parameters of a model;
a fit command that fits the parameters to the training data;
a save command that saves or loads the model to the memory; and
a score command that predicts a score based on the training data.

5. The natural language processor of claim 1, wherein the processor and the executable software code are configured to train the natural language processor based on the raw text.

6. The natural language processor of claim 1, further comprising an ensembler, wherein the software framework sits between a user interface and the ensembler.

7. The natural language processor of claim 6, wherein the ensembler is configured to instantiate machines based on the collection of natural language classifiers, wherein each of the machines is configured to load a model, to generate a score based on the training data and the model, and to save the score.

8. The natural language processor of claim 1, further comprises an aggregator, wherein the software framework sits between a user interface and the aggregator.

9. The natural language processor of claim 8, wherein the aggregator is configured to instantiate ensemblers, wherein each of the ensemblers is configured to produce confidence statistics, to generate a score based on the training data and the model, and to save the score.

10. The natural language processor of claim 1, wherein the natural language classifiers are configured to receive raw text.

11. The natural language processor of claim 1, wherein the natural language classifiers inherit from a general machine class of the application programming interface.
